(19) United States
(12) Patent Application Publication
(10) Pub. No.: US 2019/0347078 A1
(43) Pub. Date: Nov. 14, 2019

(54) Generating Application Mock-Ups Based on Captured User Sessions

(71) Applicant: International Business Machines Corporation, Armonk, NY (US)

(72) Inventor: Aleksander W. Oleszkiewicz, Lipkow (PL)

(21) Appl. No.: 15/974,864

(22) Filed: May 9, 2018

(51) Int. Cl. G06F 8/34; H04L 29/08; G06F 8/38

(52) U.S. Cl. CPC G06F 8/34; G06F 8/38; H04L 67/22

(57) ABSTRACT

An approach is provided in which an information handling system receives session data corresponding to multiple application sessions that includes multiple screen views of an application and multiple user interactions with the application. The information handling system aggregates the user interactions and the screen views into an aggregated application mapping, which includes transitions that link together the screen views based on the user interactions. In turn, the information handling system uses the aggregated application mapping to create an application mock-up that includes multiple interactive screen views that mimic the application based on the transitions.

### BACKGROUND

When training users on how to navigate and utilize a software product, a common business practice is to include hands-on exercises that allow the users to practice operations for which they are learning. In many cases, however, providing a “live” version of an application to each user is not possible or practical due to network limitations, performance requirements, computer resources, and etcetera. Similar challenges exist in many sales/pre-sales situations when a salesperson performs a product demonstration to a customer but does not have access to a live version of the software product.

To alleviate the above challenges, some of today's training and demonstration solutions use static click-through patterns that consist of manually defined paths, application screenshots, and specific clickable areas that allow a user to move along a pre-defined path. Although these solutions may visually demonstrate a specific scenario through the application, their static click-through solutions are not sufficient for educational and training purposes.

### BRIEF SUMMARY

According to one embodiment of the present disclosure, an approach is provided in which an information handling system receives session data corresponding to multiple application sessions that includes multiple screen views of an application and multiple user interactions with the application. The information handling system aggregates the user interactions and the screen views into an aggregated application mapping, which includes transitions that link together the screen views based on the user interactions. In turn, the information handling system uses the aggregated application mapping to create an application mock-up that includes multiple interactive screen views that mimic the application based on the transitions.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is an exemplary block diagram of a data processing system that implements the methods described herein;

FIG. 2 provides an extension of the information handling system environment shown in FIG. 1 to illustrate that the methods described herein can be performed on a wide variety of information handling systems which operate in a networked environment;

FIG. 3 is a diagram depicting an application mock-up generator receiving session data from multiple sources and creating an application mock-up based on the session data;

FIG. 4 is an exemplary diagram depicting a capture module sending session data to an application mock-up generator;

FIG. 5 is an exemplary diagram depicting an application mock-up generator aggregating session data and creating an application mock-up;

FIG. 6 is an exemplary diagram that shows aggregated transitions and visually depicts an aggregated application mapping;

FIG. 7 is an exemplary flowchart showing steps a capture module performs to capture session data and send the session data to a centralized application mock-up generator;

FIG. 8 is an exemplary flowchart depicting steps to aggregate session data from multiple users; and

FIG. 9 is an exemplary flowchart depicting steps to create an application mock-up.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

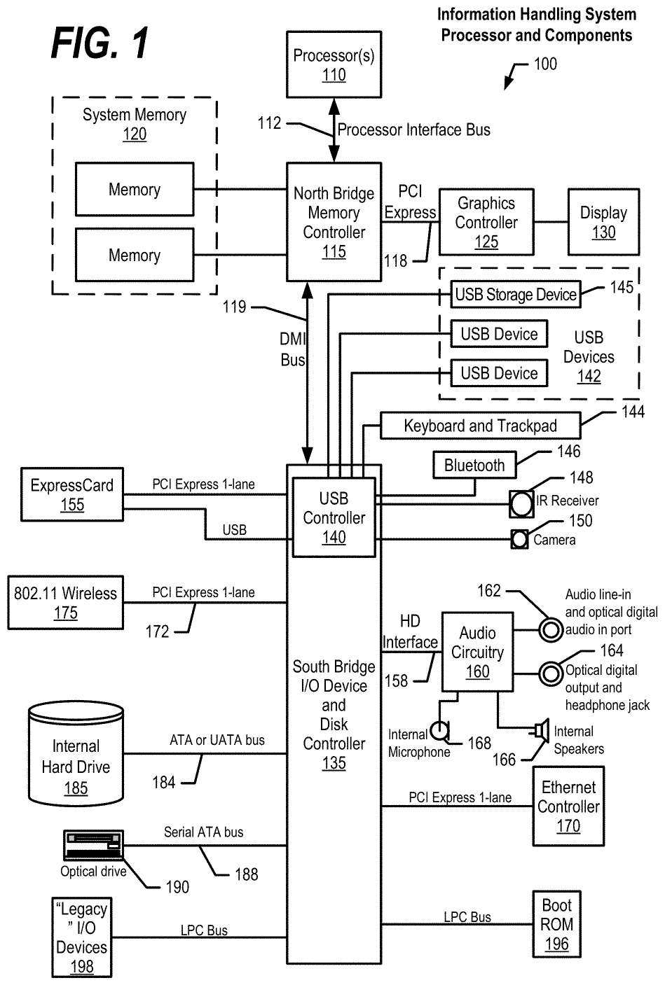

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

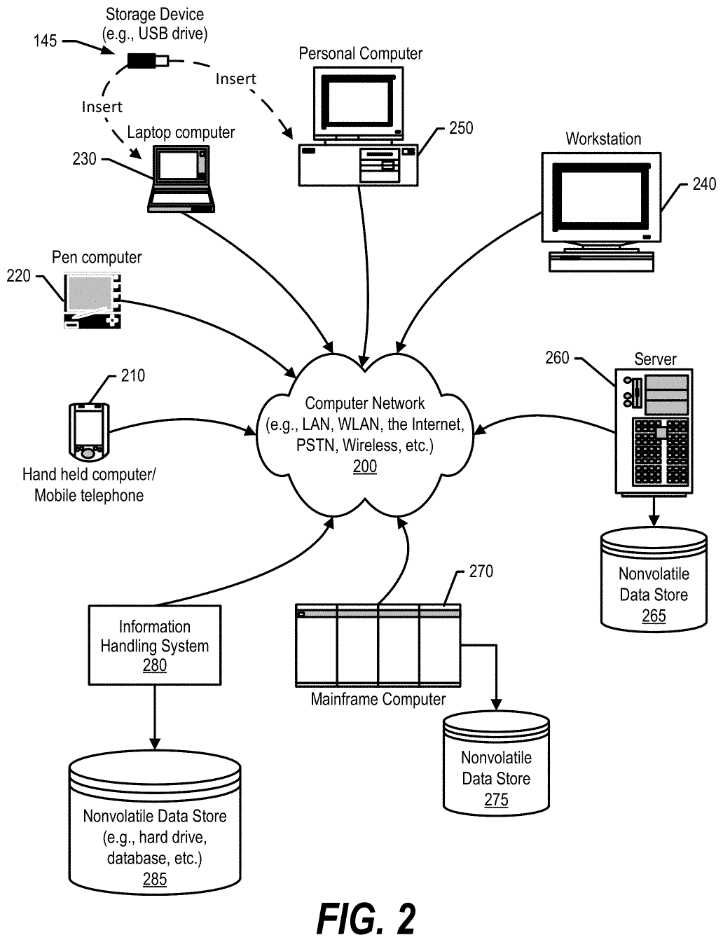

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

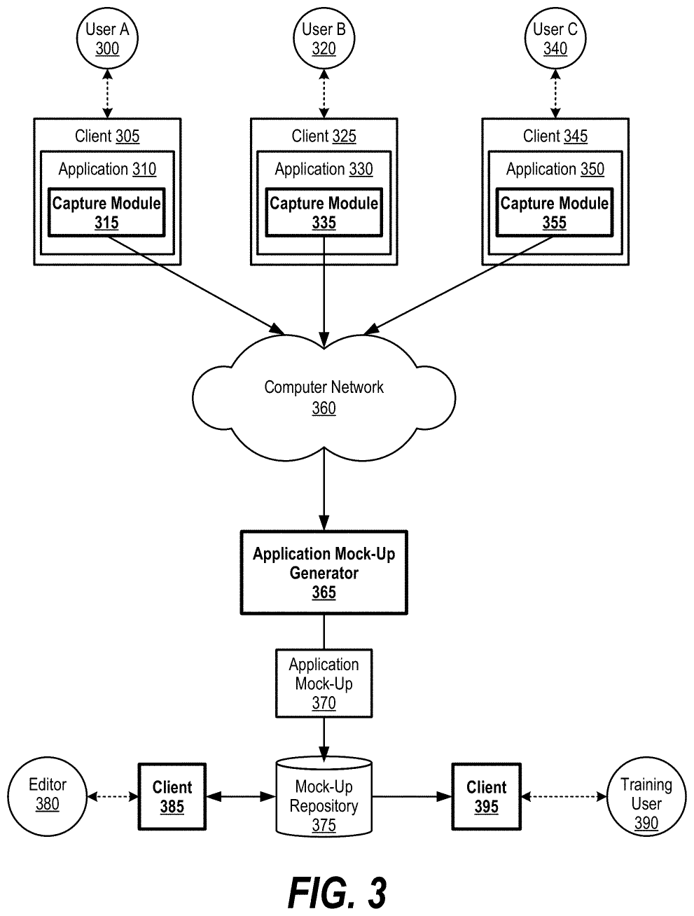

FIGS. 3 through 9 depict an approach of aggregating actual user session data from multiple users and using the aggregated user session data to create an application mock-up for subsequent training and demonstration purposes. Capture modules embedded in applications capture the session data during live user sessions and send the session data to a centralized application mock-up generator. The application mock-up generator aggregates the session data and analyses the flow of screen views and available interactive elements on each screen, and creates a working mock-up that is accessible by various users such as prospective customers and training participants. As such, the users are able to explore multiple paths of the application using their specific application mock-up without interfering with other users or requiring a live application. As discussed herein, “multiple users” may also include multiple uses performed by the same user/person.

FIG. 3 is a diagram depicting an application mock-up generator receiving session data from multiple sources and creating an application mock-up based on the session data. User A 300 interacts with application 310 using client 305. During user A 300's interactions, capture module 315 captures screen views that application 310 generates as well as interactions from user A 300, such as clicks, selections, inputs, etc. For example, capture module 315 may utilize customer experience analytics (CXA) tools to intercept content presented to user A 300 by application 310, interactions of user 300, and optionally network level data.

The captured screen view content, in one embodiment, is in a form based on a specific platform. For example, capture module 315 may capture screen view content in a form such as Document Object Model (DOM) objects, HTML page sources, or a list of visible elements with their properties defining shape, color, placement on the screen, and etcetera. The captured user interaction information may include interaction types (e.g., click, scroll, and change), interaction targets (e.g., element ID) and values (e.g., data entered by the user into a form field).

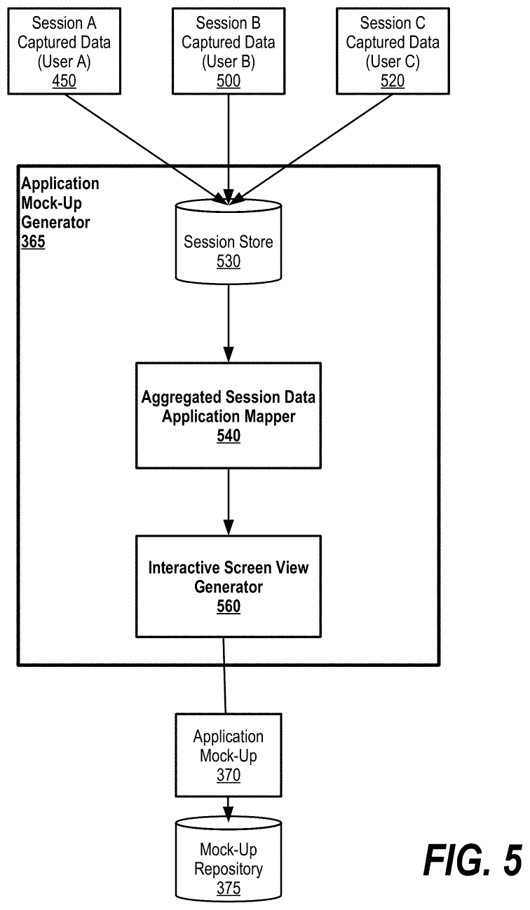

When user A 300 progresses through the session as well as when the user finishes the session, capture module 310 periodically sends the captured session data through computer network 360 to application mock-up generator 365 for further processing (see FIGS. 5, 8, 9, and corresponding text for further details). In one embodiment, capture module 315 sends session data in real-time to application mock-up generator 365.

FIG. 3 shows that application 310 is installed locally on client 305. In one embodiment, client 305 loads application 310 from a remote server. In another embodiment, application 310 may be a mobile hybrid application with a locally loaded native component and an embedded web/HTML component. In this embodiment, both application components embed capture module 315 or a portion thereof such that a remote capture component captures the web/HTML session data and a local capture component captures the native session data executing on client 305. In this embodiment, the remote capture component may send its captured session data directly to application mock-up generator 365 for analysis or use the local capture component on client 305 as a bridge.

User B 320 interfaces with client 325 to interact with application 330. During user B 320's interactions, capture module 335 captures screen views that application 330 generates as well as interactions from user B 320, such as clicks, selections, inputs, etc. When user B 320 finishes the session, or during the session, capture module 335 sends the session data through computer network 360 to application mock-up generator 365. Likewise, user C 340 interfaces with client 345 to interact with application 330. During user C 340's interactions, capture module 355 captures screen views that application 350 generates as well as interactions from user C 340, such as clicks, selections, inputs, etc. When user C 340 finishes the session, or during the session, capture module 355 sends the session data through computer network 360 to application mock-up generator 365.

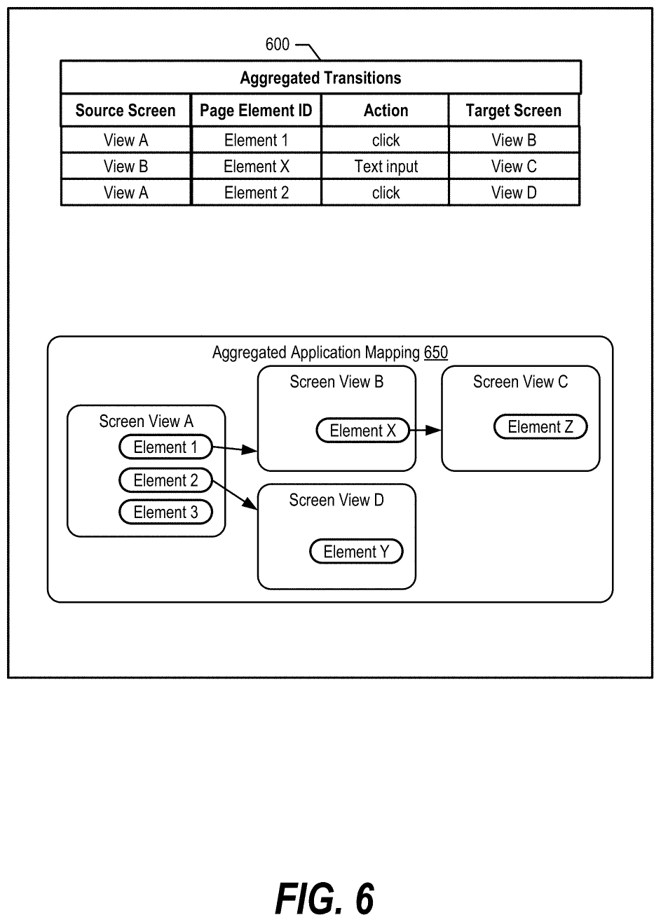

Application mock-up generator 365 receives the session data from the multiple capture modules 315, 335, and 355, and partitions the session data into screen views and user interactions to define the flow of control in the application for each session. For each interaction, application mock-up generator 365 creates a transition that links the source screen view, the page element interactions, and the target screen view (see FIG. 6 and corresponding text for further details). In one embodiment, application mock-up generator 365 receives session data corresponding to different applications. For example, each of clients 305, 325, and 345 may be executing different versions of an application and, in this example, application mock-up generator 365 separates the session data into different application “buckets” and aggregates the session data on a per-bucket basis.

Application mock-up generator 365 creates an aggregated application mapping from the aggregated transitions, and uses the aggregated application mapping to generate application mock-up 370 (see FIGS. 6, 8, 9, and corresponding text for further details). In one embodiment, application mock-up 370 is a set of interactive HTML pages based on the captured content (layout and static content). Application mock-up 370's screen views (e.g., pages) also include relevant event handlers on overlay objects for which transitions are registered in the map and become interactive (e.g. on-click listener to a button on the screen that leads to a target screen view as identified in the application map).

In one embodiment, editor 380 fine-tunes application mock-up 370 using client 385 if needed before distributing application mock-up 370 to training users 390 (e.g., customers, training participants, etc.). Editor 380 may replay each screen view and objects for which transitions from the screen view are interactive. This allows editor 380 to invoke the transitions with an option to highlight all clickable page elements. Editor 380 may have an interface to adjust automatically created transitions and object assignments. In cases when multiple screen view captures are available for a particular screen view, editor 380 decides which of the captured screen view snapshots to use to generate the application mock-up.

When editor 380 completes editing application mock-up 370, training user 390 accesses the edited version of application mock-up 370 via client 395, such as over an online replay portal or download for an off-line replay. In one embodiment, application mock-up 370 may be a demonstration mockup that allows training user 390 to navigate through all captured screen views, mimicking the look and feel of the real application.

In another embodiment, application mock-up 370 is a tutorial mock-up, or guided demonstration, that replays the application but guides the user through a specific path by presenting visual hints and optional descriptions during replay which elements to click to progress to the next stage. In yet another embodiment, application mock-up 370 is a test mock-up that checks whether a user is able to follow a specified path, or reaches a specified goal (e.g., a screen view) using a limited number of interactions (e.g., clicks) or time and provides feedback to the user and/or to a backend server.

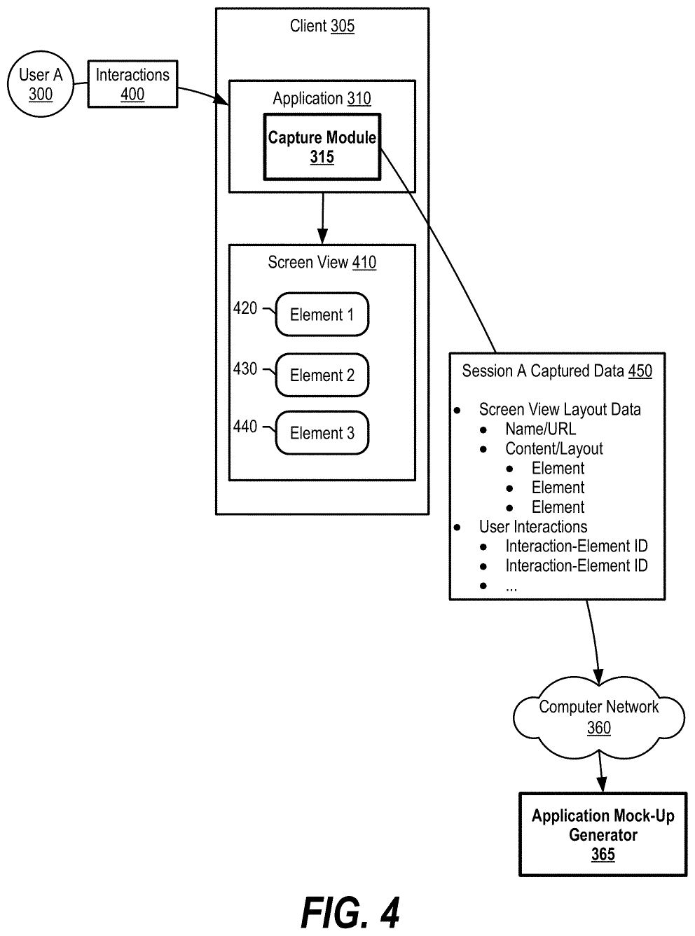

FIG. 4 is an exemplary diagram depicting a capture module sending session data to an application mock-up generator. Client 305 executes application 310 and receives interactions 400 from user A 300. During execution, capture module 315 captures screen view content (screen view 410 and elements 420, 430, and 440) as well as user interactions. As discussed herein, the screen view content is in a form available on a specific platform and the user interaction information may include the interaction types, target elements, and values (e.g. data entered by the user into a form field).

Capture module 315 may also capture changes in the screen view's content after the user's interaction, such as collecting new screen view content or collecting the difference between a previous screen view and a new screen view (e.g., additional drop down menu). When user A 300's session terminates, capture module 315 sends session A captured data 450 over computer network 360 to application mock-up generator 365 for further processing.

FIG. 5 is an exemplary diagram depicting an application mock-up generator aggregating session data and creating an application mock-up. Application mock-up generator 365 receives session data (session A captured data 450, session B captured data 500, and session C captured data 520) from various capture modules and stores the session data in session store 530. Next, aggregated session data application mapper 540 separates data from different applications (e.g., based on a unique key) into “buckets” and breaks down the session data into screen views and interactions between the screen views and defines the flow of control in the application for each session.

For each user interaction, aggregated session data application mapper 540 creates a transition that links the screen view (source screen view) on which the interaction type registered (e.g. click, change) and the page element that is the subject of the interaction (e.g. a button or a link) with the screen view registered after the interaction (target screen view). The target screen view may be the same as the source screen view, or may have the same name but slightly different content (e.g., a drop down menu), or may be a different screen view altogether.

For each new screen view captured, aggregated session data application mapper 540 checks if the screen view content is currently stored from a previous screen view analysis. If the screen view content is already stored, aggregated session data application mapper 540 compares the new layout to the previously captured layout. If the layout is the same, aggregated session data application mapper 540 links the corresponding transition to the previously stored data/screen view. If the layout is different, aggregated session data application mapper 540 stores the new layout as a new “variant” of the screen view (e.g. a home page with an open hover menu) and links the corresponding transition to the new variant. For each new screen view or a variant of an existing screen view, aggregated session data application mapper 540 downloads and stores static content corresponding to the page (e.g. pictures, style sheets, etc.). Once aggregated session data application mapper 540 finishes analyzing the interactions and screen views, aggregated session data application mapper 540 creates an aggregated application mapping as discussed herein that links the screen views based on the interactions (see FIGS. 6, 8, 9, and corresponding text for further details).

Interactive screen view generator 560 uses the aggregated application mapping to generate application mock-up 370, which includes screen views (e.g., HTML pages) based on the captured layout and static content. Interactive screen view generator 560 overlays relevant event handlers onto objects based on the aggregated application mapping that become interactive during replay (e.g. on-click listener to a button on the screen, which leads to the relevant screen view as identified in the application map).

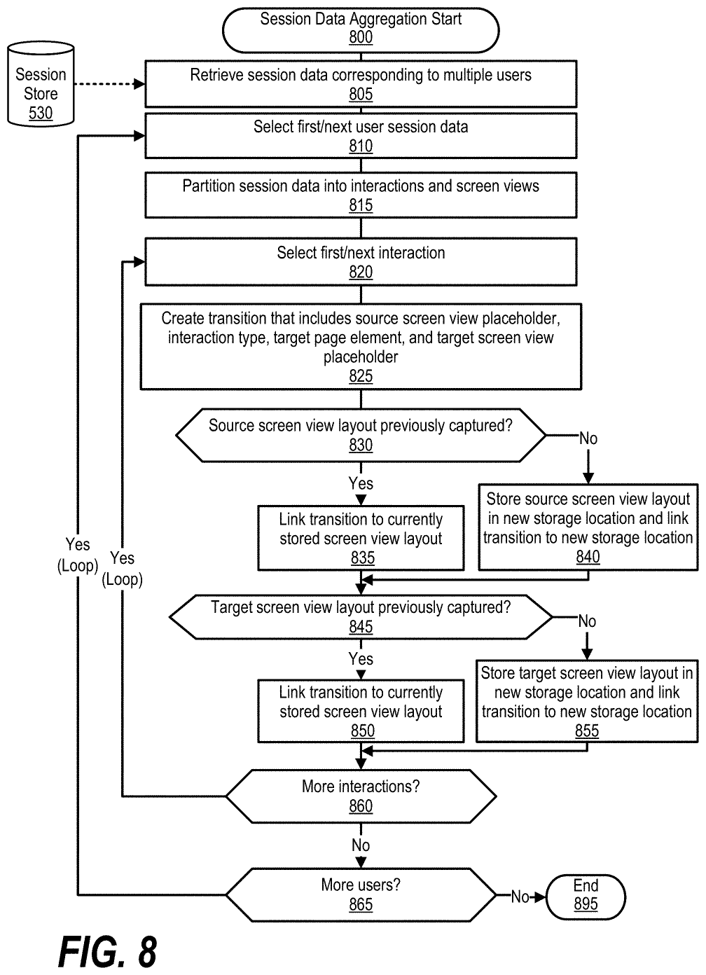

FIG. 6 is an exemplary diagram that shows aggregated transition table entries and visually depicts an aggregated application mapping. Application mock-up generator 365 creates aggregated transitions 600 based on received user session data as discussed herein. The aggregated transition entries include a source screen identifier, a page element identifier, a user action on the page element, and a target screen identifier. As discussed herein, application mock-up generator 365 analyzes each screen and stores its screen view content or points to already stored layout content. In turn, the identifiers in the aggregated transition entries may point to the storage locations of their respective screen views (see FIG. 8 and corresponding text for further details).

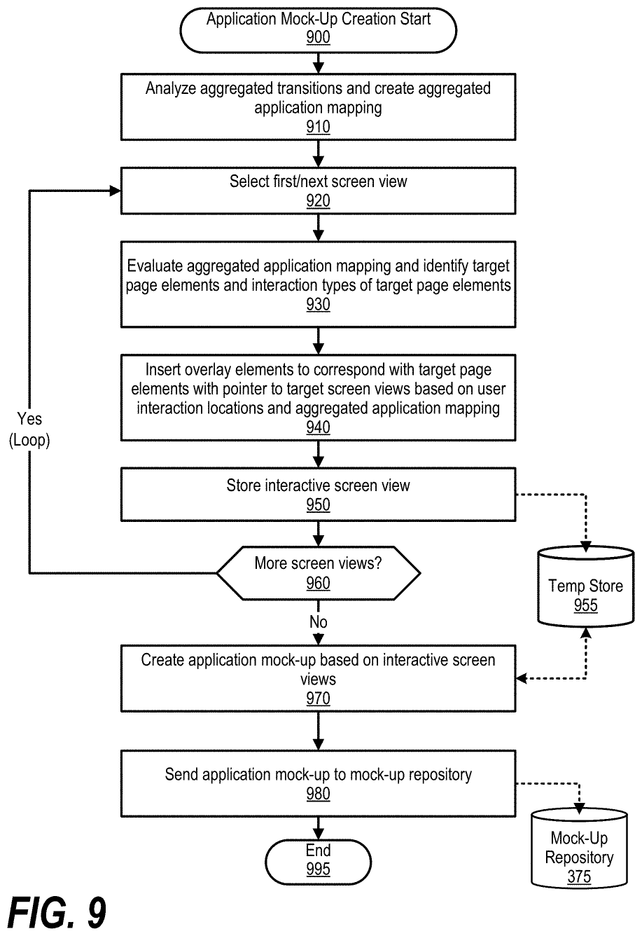

Aggregated application mapping 650 corresponds to aggregated transitions 600 and links the various screen views together through user interactions that include the user actions to their corresponding page elements. As discussed herein, application mock-up generator 365 uses aggregated application mapping 650 to generate application mock-up 370, which is accessible by users for real-time demonstrations and training purposes (see FIG. 9 and corresponding text for further details).

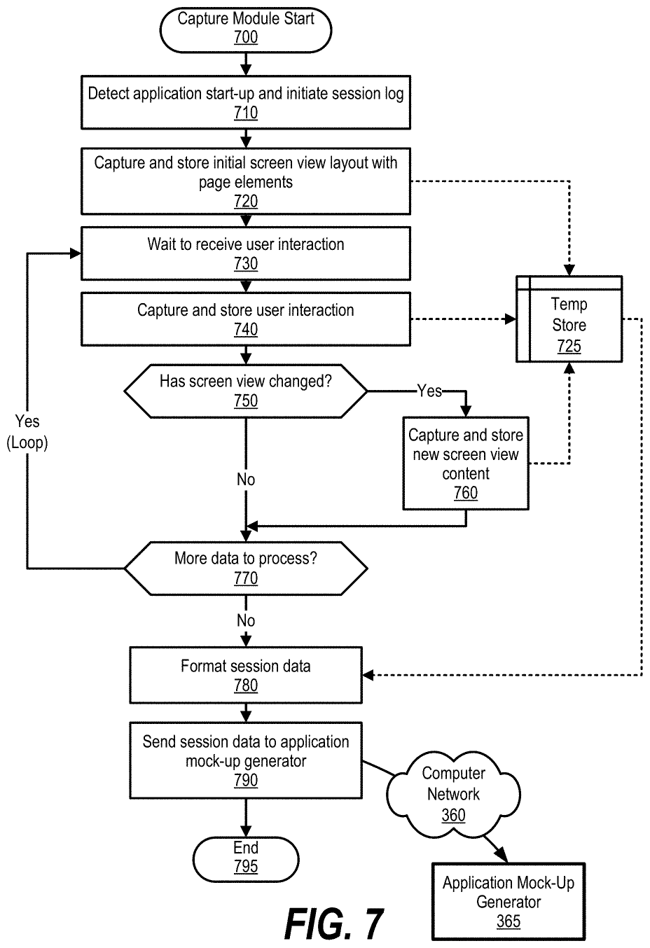

FIG. 7 is an exemplary flowchart showing steps a capture module performs to capture session data and send the session data to a centralized application mock-up generator. FIG. 7 processing commences at 700 whereupon, at step 710, the process detects an application start-up and initiates a session log. At step 720, the process captures and stores initial screen view content with page elements in temp store 725. For example, the process may capture screen view content in the form available on a specific platform such as Document Object Model (DOM) objects, HTML source of a page, or a list of visible elements with their properties defining shape, color, placement on the screen, and etcetera.

At step 730, the process waits to receive a user interaction and, at step 740, the process captures and stores the user interaction. For example, the process may capture information about the user interaction type (e.g., click, scroll, change), interaction targets (e.g., page element ID) and values (e.g., data entered by the user into a form field). The process determines as to whether the screen view content changes (decision 750). For example, the screen view may now have a drop down menu or the screen view may display an entirely different web page. If the screen view content changes, then decision 750 branches to the ‘yes’ branch whereupon, at step 760, the process captures and stores the new screen view. In one embodiment, the process captures changes between the previous screen view and the new screen view.

On the other hand, if the screen view content does not change, then decision 750 branches to the ‘no’ branch. In one embodiment, when the screen view content does not change, the process records the event as a transition to the same screen view so that information about the interaction is not discarded.

The process determines if there is more data to process or whether the application is still open (decision 770). For example, if the time since the last batch of data from an application is less than a configurable timeout, the application may still be open. If there is more data to process, then decision 770 branches to the ‘yes’ branch, which loops back to capture more user interactions and screen views. This looping continues until there is no more data to be processed or the application is considered as terminated, at which point decision 770 branches to the ‘no’ branch exiting the loop. At step 780, the process formats the session data by appending an application “bucket” identifier and a timestamp. At step 790, the process sends the formatted session data through computer network 360 to application mock-up generator 365 for further processing (see FIGS. 8, 9, and corresponding text for further details). FIG. 7 processing thereafter ends at 795.

FIG. 8 is an exemplary flowchart depicting steps to aggregate session data from multiple users. FIG. 8 processing commences at 800 whereupon, at step 805, the process retrieves session data from multiple users that are received and temporarily stored in session store 530. In one embodiment, the process separates the session data into different application “buckets.” For example, if the process receives session data from multiple users interacting with application X and application Y, the process separates the session data into an application X session data bucket and an application Y session data bucket.

At step 810, the process selects the first user session data (for a particular application) and, at step 815, the process partitions the selected session data into user interactions and screen views. At step 820, the process selects the first user interaction and, at step 825, the process creates a transition entry that includes a source screen view placeholder, an interaction type (click), a target element ID, and a target screen view placeholder. The source screen view placeholder and target screen view placeholder are filled in during the steps 830-855 discussed below. As those skilled in the art can appreciate, the process may perform steps 825-855 in a different order than what is shown in FIG. 8.

The process determines as to whether the source screen view content is already stored in a storage location (decision 830). If the source screen view content is already stored in a storage location, then decision 830 branches to the ‘yes’ branch whereupon, at step 835, the process links the transition to the currently stored screen view. For example, the process may enter a screen view identifier in the source screen view placeholder that points to the storage location. On the other hand, if the source screen view is not previously captured, then decision 830 branches to the ‘no’ branch whereupon, at step 840, the process stores the source screen view in a new storage location and links the transition to the newly stored screen view storage location.

Likewise, the process determines as to whether the target screen view content is already stored in a storage location (decision 845). If the target screen view content is already stored in a storage location, then decision 845 branches to the ‘yes’ branch whereupon, at step 850, the process links the transition to the currently stored screen view. On the other hand, if the target screen view is not previously captured, then decision 845 branches to the ‘no’ branch whereupon, at step 855, the process stores the target screen view in a new storage location and links the transition to the newly stored screen view.

The process determines as to whether there are more user interactions in the selected user's session data (decision 860). If there are more user interactions, then decision 860 branches to the ‘yes’ branch which loops back to process the next user interaction. This looping continues until there are no more user interactions to process for the selected user, at which point decision 860 branches to the ‘no’ branch exiting the loop. The process determines as to whether there is more session data to process from other users (decision 865). If there is more session data to process from other users, then decision 865 branches to the ‘yes’ branch which loops back to select the next user session data. This looping continues until there are no more user session data to process, at which point decision 865 branches to the ‘no’ branch exiting the loop. FIG. 8 processing thereafter ends at 895.

FIG. 9 is an exemplary flowchart depicting steps to create an application mock-up. FIG. 9 processing commences at 900 whereupon, at step 910, the process analyzes aggregated transitions (created in FIG. 8) and creates an aggregated application mapping. In one embodiment, editor 380 may create the aggregated application mapping based on a presented list, visual graph, initial visual rendering of the mockup, or other approaches that allow editor 380 to review captured screen views and related transitions. In this embodiment, editor 380 may select the capture screen views to use for the mockup generation, especially in situations when the aggregated transition entries include more than one possible transition for the same source screen view, page element and user action. In another embodiment, application mock-up generator 365 automatically creates the aggregated application mapping based on predefined rules. For example, application mock-up generator 365 may analyze all unique transitions and use the most recently recorded transition when more than one possible transition is available.

At step 920, the process selects a first stored screen view based on the aggregated application mapping. For example, the first screen view may be a top level parent web page view. At step 930, the process evaluates the aggregated application mapping and identifies target page elements (e.g., buttons) and interaction types (e.g., mouse clicks) of the target page elements. At step 940, the process adds overlay elements onto the screen view content to correspond with the target elements. The overlay elements are configured to receive the interaction type and point to a corresponding target screen view based on the aggregated application mapping.

At step 950, the process stores the interactive screen view in temp store 955. The process determines as to whether there are more screen views to evaluate (decision 960). If there are more screen views to evaluate, then decision 960 branches to the ‘yes’ branch which loops back to select and process the next screen view. This looping continues until each of the screen views are evaluated, at which point decision 960 branches to the ‘no’ branch exiting the loop.

At step 970, the process creates an application mock-up based on the interactive screen views stored in temp store 955. In one embodiment, the process generates the application mock-up as a set of static HTML pages (enhanced with JavaScript invoking transitions) and static content captured from the application (images, styles, etc.). In another embodiment, the process introduces rules to modify the stored content when generating the mockup. For example, a rule may identify transitions defined in the application map that are clickable (and optionally visually highlighted e.g. by changing a border or background color). In another example, a rule may define an action when a user clicks on an element whether the user is presented with a screen view change (e.g. opened menu) or is presented with a new screen view as defined in the aggregated application mapping.

At step 980, the process sends the application mock-up to mock-up repository 375, where users may access and utilized the application mock-up as discussed herein. FIG. 9 processing thereafter ends at 995.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
receiving session data corresponding to a plurality of application sessions, wherein the session data comprises a plurality of screen views of an application and a plurality of user interactions with the application;
aggregating the plurality of user interactions and the plurality of screen views into an aggregated application mapping, wherein the aggregated application mapping comprises one or more transitions that link together the plurality of screen views based on the plurality of user interactions; and
creating, based on the aggregated application mapping, an application mock-up comprising a plurality of interactive screen views that mimic the application based on the one or more transitions.

2. The method of claim 1 wherein the session data comprises a first set of session data and a second set of session data, the first set of session data corresponding to a first user interacting with the application on a first client, and the second set of session data corresponding to a second user interacting with the application on a second client.

3. The method of claim 2 wherein the aggregating further comprises:
analyzing, in the first set of session data, a first one of the plurality of screen views and a first one of the plurality of user interactions interacting with a first page element on the first screen view;
analyzing, in the second set of session data, a second one of the plurality of screen views and a second one of the plurality of user interactions interacting with a second page element on the second screen view;
determining that the first screen view matches the second screen view; and
in response to determining that the first screen view matches the second screen view, creating a first one of the plurality of interactive screen views comprising the first screen view, a first overlay object corresponding to the first page element, and a second overlay object corresponding to the second page element.

4. The method of claim 3 wherein the first user interaction transitions to a third one of the plurality of screen views, and wherein the second user interaction transitions to a fourth one of the plurality of screen views, the method further comprising:
linking a first event handler to the first overlay object that targets the third screen view; and
linking a second event handler to the second overlay object that targets the fourth screen view.

5. The method of claim 1 wherein the aggregating further comprises:
evaluating a first one of the plurality of user interactions, wherein the first user interaction corresponds to a first one of the plurality of screen views, a page element in the first screen view; a user interaction type with the first page element, and a second one of the plurality of screen views;
creating a transition entry that identifies the first screen view, the page element, the user interaction type, and the second screen view.

6. The method of claim 1 wherein, prior to the aggregating, the method further comprises:
determining that the session data corresponds to both a first application and a second application that is different than the first application;
separating the session data into a first application session data corresponding to the first application and a second application session data corresponding to the second application; and
performing the aggregating utilizing the first application session data.

7. The method of claim 1 further comprising:
modifying the application mock-up by an editor user, wherein the modifying comprises changing at least one of the plurality of interactive screen views; and
distributing the modified application mock-up to one or more subsequent users.

8. An information handling system comprising:
one or more processors;
a memory coupled to at least one of the processors;
a set of computer program instructions stored in the memory and executed by at least one of the processors in order to perform actions of:
receiving session data corresponding to a plurality of application sessions, wherein the session data comprises a plurality of screen views of an application and a plurality of user interactions with the application;
aggregating the plurality of user interactions and the plurality of screen views into an aggregated application mapping, wherein the aggregated application mapping comprises one or more transitions that link together the plurality of screen views based on the plurality of user interactions; and
creating, based on the aggregated application mapping, an application mock-up comprising a plurality of interactive screen views that mimic the application based on the one or more transitions.

9. The information handling system of claim 8 wherein the session data comprises a first set of session data and a second set of session data, the first set of session data corresponding to a first user interacting with the application on a first client, and the second set of session data corresponding to a second user interacting with the application on a second client.

10. The information handling system of claim 9 wherein the processors perform additional actions comprising:
analyzing, in the first set of session data, a first one of the plurality of screen views and a first one of the plurality of user interactions interacting with a first page element on the first screen view;
analyzing, in the second set of session data, a second one of the plurality of screen views and a second one of the plurality of user interactions interacting with a second page element on the second screen view;
determining that the first screen view matches the second screen view; and
in response to determining that the first screen view matches the second screen view, creating a first one of the plurality of interactive screen views comprising the first screen view, a first overlay object corresponding to the first page element, and a second overlay object corresponding to the second page element.

11. The information handling system of claim 10 wherein the first user interaction transitions to a third one of the plurality of screen views, and wherein the second user interaction transitions to a fourth one of the plurality of screen views, the method further comprising:
linking a first event handler to the first overlay object that targets the third screen view; and
linking a second event handler to the second overlay object that targets the fourth screen view.

12. The information handling system of claim 8 wherein the processors perform additional actions comprising:
evaluating a first one of the plurality of user interactions, wherein the first user interaction corresponds to a first one of the plurality of screen views, a page element in the first screen view; a user interaction type with the first page element, and a second one of the plurality of screen views;
creating a transition entry that identifies the first screen view, the page element, the user interaction type, and the second screen view.

13. The information handling system of claim 8 wherein, prior to the aggregating, the processors perform additional actions comprising:
determining that the session data corresponds to both a first application and a second application that is different than the first application;
separating the session data into a first application session data corresponding to the first application and a second application session data corresponding to the second application; and
performing the aggregating utilizing the first application session data.

14. The information handling system of claim 8 wherein the processors perform additional actions comprising:
modifying the application mock-up by an editor user, wherein the modifying comprises changing at least one of the plurality of interactive screen views; and
distributing the modified application mock-up to one or more subsequent users.

15. A computer program product stored in a computer readable storage medium, comprising computer program code that, when executed by an information handling system, causes the information handling system to perform actions comprising:
receiving session data corresponding to a plurality of application sessions, wherein the session data comprises a plurality of screen views of an application and a plurality of user interactions with the application;
aggregating the plurality of user interactions and the plurality of screen views into an aggregated application mapping, wherein the aggregated application mapping comprises one or more transitions that link together the plurality of screen views based on the plurality of user interactions; and
creating, based on the aggregated application mapping, an application mock-up comprising a plurality of interactive screen views that mimic the application based on the one or more transitions.

16. The computer program product of claim 15 wherein the session data comprises a first set of session data and a second set of session data, the first set of session data corresponding to a first user interacting with the application on a first client, and the second set of session data corresponding to a second user interacting with the application on a second client.

17. The computer program product of claim 16 wherein the information handling system performs further actions comprising:
analyzing, in the first set of session data, a first one of the plurality of screen views and a first one of the plurality of user interactions interacting with a first page element on the first screen view;
analyzing, in the second set of session data, a second one of the plurality of screen views and a second one of the plurality of user interactions interacting with a second page element on the second screen view;
determining that the first screen view matches the second screen view; and
in response to determining that the first screen view matches the second screen view, creating a first one of the plurality of interactive screen views comprising the first screen view, a first overlay object corresponding to the first page element, and a second overlay object corresponding to the second page element.

18. The computer program product of claim 17 wherein the first user interaction transitions to a third one of the plurality of screen views, and wherein the second user interaction transitions to a fourth one of the plurality of screen views, the method further comprising:
linking a first event handler to the first overlay object that targets the third screen view; and
linking a second event handler to the second overlay object that targets the fourth screen view.

19. The computer program product of claim 15 wherein the information handling system performs further actions comprising:
evaluating a first one of the plurality of user interactions, wherein the first user interaction corresponds to a first one of the plurality of screen views, a page element in the first screen view; a user interaction type with the first page element, and a second one of the plurality of screen views;
creating a transition entry that identifies the first screen view, the page element, the user interaction type, and the second screen view.

20. The computer program product of claim 15 wherein, prior to the aggregating, the information handling system performs further actions comprising:
determining that the session data corresponds to both a first application and a second application that is different than the first application;
separating the session data into a first application session data corresponding to the first application and a second application session data corresponding to the second application; and
performing the aggregating utilizing the first application session data.
